(19) United States
(12) Patent Application Publication
(10) Pub. No.: US 2009/0086499 A1
(43) Pub. Date: Apr. 2, 2009

(54) CAR SPOILER HAVING LIGHT-EMITTING EFFECT

(76) Inventor: Rocky Yi-Ping LIN, Taipei City (TW)

Correspondence Address: HDLS Patent & Trademark Services, P.O. BOX 220746, CHANTILLY, VA, 20153-0746, US

(21) Appl. No.: 11/862,466

(22) Filed: Sep. 27, 2007

(51) Int. Cl. F21S 8/10

(52) U.S. Cl. 362/487

(57) ABSTRACT

A car spoiler having a light-emitting effect includes a plate body, a light-emitting module and a cover. The plate body is a light-transmitting plate and is provided with notches thereon. The light-emitting module is provided on one side of the long side of the plate body and has a plurality of light-emitting units. The illuminating direction of each light-emitting unit is oriented from the long side toward the interior of the plate body. The cover is used to cover the exterior of the light-emitting module and is connected with the plate body. Via this arrangement, the light emitted by the light-emitting module can be projected on the plate body uniformly, thereby increasing the aesthetic effect of the spoiler.

### BACKGROUND OF THE INVENTION

1. Field of the Invention

The present invention relates to a spoiler, and in particular to a spoiler mounted on a tail portion of a car.

2. Description of Prior Art

The primary function of a spoiler is to allow the airflow pass through the tail portion of the car body to provide a sufficient downward pressure. This downward pressure allows the car body to grasp the ground tightly, thereby avoiding the car from losing control when running at high speed or turning. Further, this downward pressure makes the driving wheel of a rear wheel drive car to provide the power continuously, thereby avoiding the phenomenon that the insufficient downward pressure causes the car body to drift and thus loses the power. In addition to the function of stabilizing the car body, recently, the other additional values of the spoiler are also improved. Increasing the aesthetic appearance and shining effect of the spoiler can satisfy the consumers with the demands for additional values. Therefore, the shape designs of the spoilers currently available in the market have been modified in various ways, thereby showing the unique style of individuals.

In prior art, U.S. Pat. No. 7,052,074 entitled “Angularly Adjustable Illuminated Spoiler” discloses an angularly adjustable illuminated spoiler, in which a light-emitting module is provided in an opening of the spoiler and is positioned between a bracket supporting plate and an end cover. The light-emitting module is oriented toward a symmetrical position in the center of the spoiler, so that the light-emitting module can provide a light-emitting effect for the central portion of the spoiler, thereby showing the notches in the area more clearly. Although it is a good design to locate the light-emitting module between the bracket supporting plate and the end cover, only the notches in the central portion can be displayed. It is a pity that the other portions of the spoiler are not well used. Furthermore, the brightness of the central position of the spoiler may become uneven because the light source is gradually decreased from the outside to the inside.

### SUMMARY OF THE INVENTION

In view of the above drawbacks, the present invention provides a car spoiler having a light-emitting effect, in which a long side portion of the plate body is provided with a light-emitting module, and a cover is used to cover one side of the long side portion of the plate body. Further, via the light-transmitting property of the plate body, when the light-emitting module is lighted up, the light generated by the light-emitting module can be diffused directly in the plate body, thereby increasing the aesthetic effect of the spoiler.

The present invention is to provide a car spoiler which the structure is simple and easy to assemble. Each light-emitting unit of the light-emitting module can be projected on the plate body uniformly, thereby increasing the shining effect.

The technical measures of the present invention for solving the drawbacks of prior art are as follows.

The present invention is configured to include a plate body, a light-emitting module and a cover. The plate body is a light-transmitting plate with notches provided thereon. The plate body has a long side. The light-emitting module is provided on one side of the long side of the plate body and has a plurality of light-emitting units. The illuminating direction of each light-emitting unit is oriented from the long side toward the interior of the plate body. The cover is used to cover the exterior of the light-emitting module and is connected with the plate body.

Further, the other function of the cover is to protect the light-emitting module and guide the light to be projected toward the plate body.

The above-mentioned light-emitting module allows the light-emitting units to be inserted correctly into grooves provided in the plate body, so that the light of the light-emitting unit in the range of the diffusing angle can be fully projected in the plate body. In this way, the present invention can achieve the best light-emitting effect to spread within the plate body.

In comparison of the effect of prior art, according to the present invention, the light can be projected from the long side of the plate body, so that the car spoiler can achieve a light-emitting effect in the whole structure, thereby expanding the design of the notches and the area of depicted patterns. Therefore, the aesthetic appearance and the shining effect can be further improved.

### BRIEF DESCRIPTION OF THE DRAWINGS

FIG. 1 is an exploded perspective view of the present invention;

FIG. 2 is an assembled view of the present invention;

FIG. 3 is an assembled view of the present invention showing that it is connected to a fixing seat;

FIG. 4 is an assembled view of the present invention showing that it is applied to a car body; and

FIG. 5 is an exploded perspective view showing another embodiment of the present invention.

### DETAILED DESCRIPTION OF THE INVENTION

The detailed description and the technical contents of the present invention will be explained with reference to the accompanying drawings. However, it should be understood that the drawings are illustrative only but not intended to limit the present invention thereto.

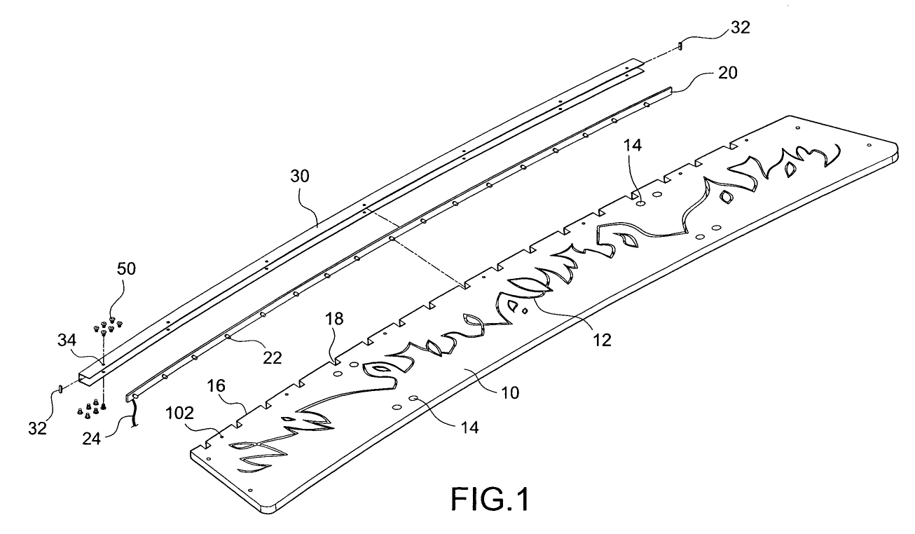

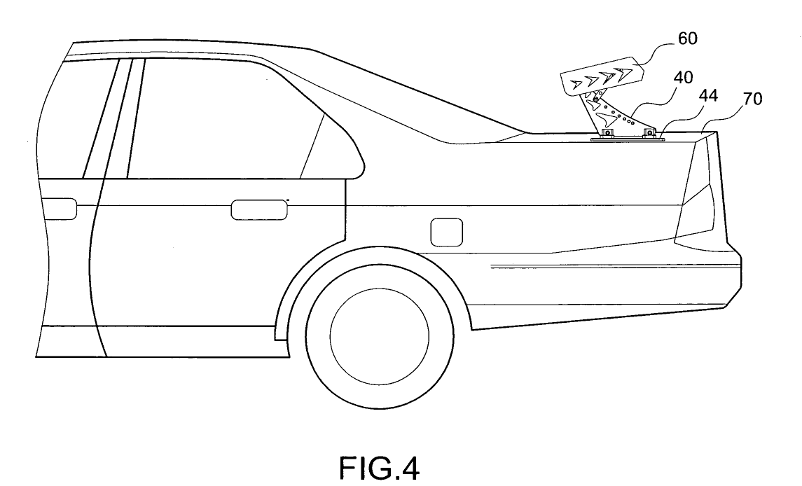

With reference to FIG. 1, it is an exploded perspective view showing each part of a car spoiler. The car spoiler includes a plate body 10, a light-emitting module 20 and a cover 30. The plate body 10 is a light-transmitting plate. For example, acryl, glass fibers, carbon fibers or translucent plate can be used to make the plate body. The plate body 10 is provided with notches 12 by means of a scribing process and a plurality of connecting portions 14 for connecting with a fixing seat 4 (FIG. 4).

The light-emitting module 20 is provided at one side of a long side 16 of the plate body 10. The long side 16 is substantially parallel to the transverse direction of a car body, as shown in FIG. 4. The light-emitting units 22 on the light-emitting module 20 are each provided to face the long side 16 of the plate body 10. The light-emitting unit 22 can be a laser that emits light toward the front or a light-emitting diode. Therefore, the light emitted by the light-emitting module 20 can be diffused directly within the plate body 10, so that the notches 12 on the plate body 10 can be seen very clearly. The power of the light-emitting module 20 is supplied by means of a power supply line 24 that is electrically connected to a power-supplying system of the car. Further, the long side 16 of the plate body 10 can be provided with a plurality of rectangular grooves 18. The positions of the grooves allow the light-emitting units 22 to be exactly inserted therein, so that the light of the light-emitting unit 22 in the range of diffusing angle can be fully projected into the plate body 10. In this way, the present invention achieves the best light-emitting effect to spread in the whole plate body 10, thereby reducing the width of the car spoiler greatly.

The cover 30 is used to cover the exterior of the light-emitting module 20. The cover 30 is used to protect the light-emitting module from the invasion of foreign matters, such as water or dust. Further, the cover has a function of guiding the light to project toward the plate body 10. In order to protect the light-emitting module 20 completely, the cover 30 used in the present invention is formed into a flat-bottomed U-lettered shape. However, the other kinds of covers that can cover the exterior of the light-emitting module 20 and can be combined with the plate body 10 may be also used, which still falls within the scope of the present invention. In assembly, screw elements 50 penetrate through penetrating holes 34 of the cover 30 and are fixedly connected to fixing holes 102 of the plate body 10. Further, waterproof pads 32 are sandwiched on both sides of the cover 30 and the light-emitting module 20, thereby blocking the invasion of foreign matters or moisture. Therefore, the possibility of affecting the light-emitting module 20 and the circuit thereof by the external environment can be reduced.

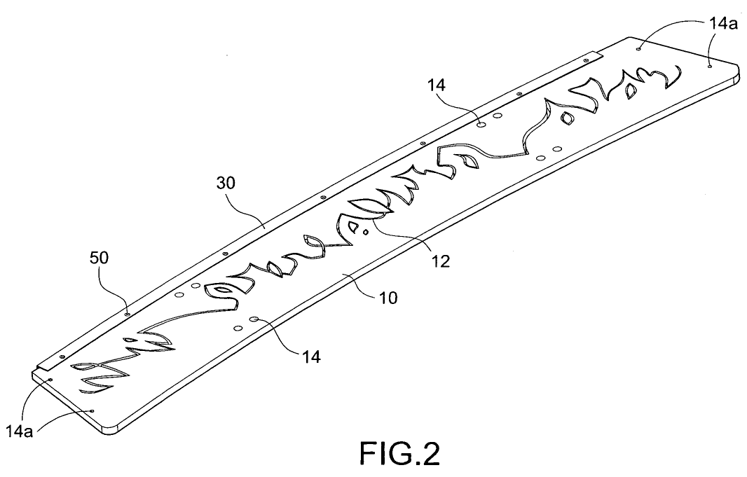

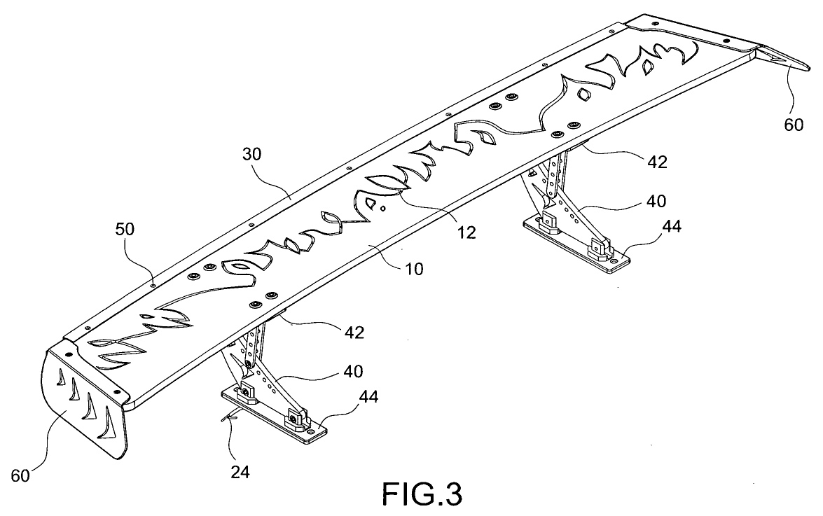

With reference to FIG. 2, after the present invention is assembled completely, the light-emitting module 20 is covered between the cover 30 and the plate body 10. The plate body 10 is provided with a plurality of connecting portions 14a for connecting with the fixing seat 4, and in addition, short sides of the plate body 10 is provided with a plurality of connecting portions 14a, thereby joining to side fins 60 shown in FIG. 3 to increase the aesthetic effect.

FIG. 3 is an assembled view of the present invention showing that it is connected to a fixing seat, and FIG. 4 is an assembled view of the present invention showing that it is applied to a car body. In FIG. 3, the car spoiler of the present invention is connected to two fixing seats 40, thereby locking a support 42 of the fixing seat 40 to the connecting portions 14 of the plate body 10. The base 44 of the fixing seat 40 is combined with a car body as shown in FIG. 4. The power of the light-emitting module 20 is supplied by means of electrically connecting a power supply line 24 along the fixing seat 40 to a power-supplying system of the car body 70. In this way, the spoiler, the fixing seat 49 and the car body 70 are combined together completely.

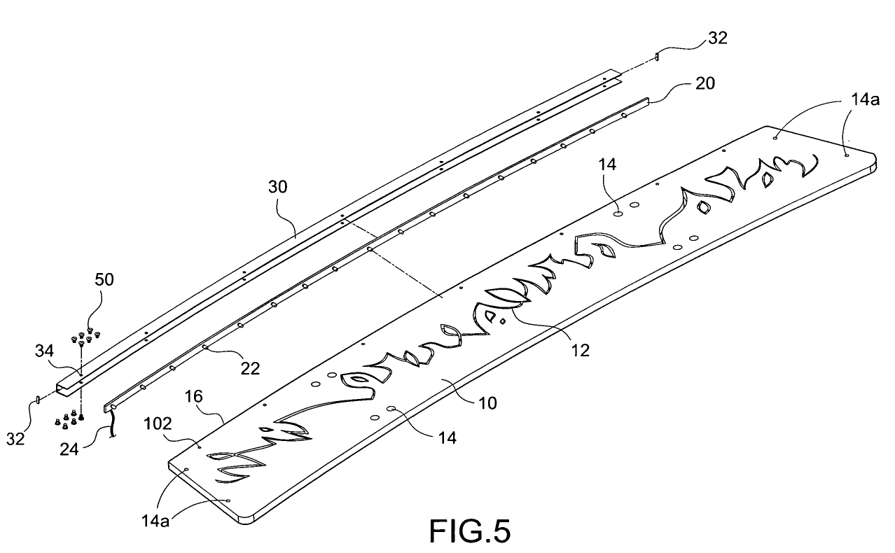

With reference to FIG. 5, it is an exploded perspective view showing another embodiment of the present invention. In addition to the previous embodiment, the plate body 10 of the present invention can be formed into a flat end surface without the grooves 18 shown in the previous embodiment. Via this arrangement, the present embodiment can also generate the same effect as that of the previous embodiment.

According to the above, the car spoiler having a light-emitting effect of the present invention can provide stability in driving. Further, shining notches and colorful variations can be generated during the driving, so that the car spoiler can have more effects.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A car spoiler having a light-emitting effect, comprising:
a plate body being a light-transmitting plate and being provided with notches thereon, the plate body having a long side;
a light-emitting module provided on one side of the long side of the plate body, the light-emitting module having a plurality of light-emitting units, the illuminating direction of each light-emitting unit being oriented from the long side toward the interior of the plate body; and
a cover covering the exterior of the light-emitting module and being connected with the plate body.

2. The car spoiler having a light-emitting effect according to claim 1, wherein the long side of the plate body is substantially parallel to the transverse direction of a car body.

3. The car spoiler having a light-emitting effect according to claim 2, wherein the long side of the plate body is provided with a plurality of grooves for allowing each of the light-emitting units to be accommodated therein.

4. The car spoiler having a light-emitting effect according to claim 1, wherein the long side of the plate body is provided with a plurality of fixing holes, the cover is provided with a plurality of penetrating holes that correspond to the fixing holes, and screw elements penetrate through the penetrating holes and are fixedly connected thereto.

5. The car spoiler having a light-emitting effect according to claim 1, wherein the plate body is a transparent plate.

6. The car spoiler having a light-emitting effect according to claim 1, wherein the plate body is a translucent plate.

7. The car spoiler having a light-emitting effect according to claim 1, wherein the cover is formed into a flat-bottomed U-lettered shape.

8. The car spoiler having a light-emitting effect according to claim 1, wherein the light-emitting unit is a diode.

9. The car spoiler having a light-emitting effect according to claim 1, further comprising waterproof pads sandwiched on both sides of the cover and the light-emitting module.
